(19) United States
(12) Patent Application Publication
(10) Pub. No.: US 2025/0121793 A1
(43) Pub. Date: Apr. 17, 2025

(54) SYSTEM OF ON-DEMAND TUNABLE STIFFNESS FOR PEDESTRIAN PROTECTION

(71) Applicant: GM Global Technology Operations LLC, Detroit, MI (US)

(72) Inventors: Hanif Muhammad, Ann Arbor, MI (US); Neela Praveenkumar, Bangalore (IN); Rohan Dhakate, Bangalore (IN)

(73) Assignee: GM Global Technology Operations LLC, Detroit, MI (US)

(21) Appl. No.: 18/488,210

(22) Filed: Oct. 17, 2023

(51) Int. Cl. B60R 21/34; F03G 7/06

(52) U.S. Cl. CPC B60R 21/34; F03G 7/0614; B60R 2021/343

(57) ABSTRACT

A vehicle includes a first vehicle component having a shape memory polymer (SMP) including a first modulus of elasticity in a first state and a second modulus of elasticity in a second state, the second modulus of elasticity being less than the first modulus of elasticity, a heating element selectively movable from an OFF state to an ON state to supply the SMP with heat, the SMP moving from the first state to the second state in response to the heating element moving from the OFF state to the ON state, and at least one sensor attached to the vehicle and configured to generate an electric signal in response to a force of a predetermined magnitude being applied to the vehicle to move the heating element from the OFF state to the ON state.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against present disclosure.

The present disclosure relates generally to a system of on-demand tunable stiffness for components under a hood or behind a fascia (bumper cover) of a vehicle to meet regulatory and consumer metric requirements related to safety and, more particularly, to protect pedestrians during an impact with a moving vehicle. The disclosure is not limited, in its concept or approach, to the following example configurations but, rather, can be extended to other automotive or non-automotive applications where an on-demand change in a component's stiffness is needed in real time.

Vehicle components are designed to meet cross-functional, often conflicting, requirements. In some instances, these components may need to deform in a pre-determined fashion to meet regulatory and consumer safety requirements. For example, components may need to deform to meet regulatory and consumer safety requirements for pedestrian protection or occupant safety, while concurrently retaining their material and geometrical stiffness to meet durability, modal, and other cross-functional requirements. In other instances, internal components, beneath an otherwise deformable component such as an exterior body panel, may maintain their stiffness and geometry upon contact with an object. For example, while a vehicle hood may deform in response to a head-impact event, underlying vehicle components are often not deformable when subjected to such impact events.

### SUMMARY

In one configuration, a vehicle is provided and includes a first vehicle component having a shape memory polymer (SMP) including a first modulus of elasticity in a first state and a second modulus of elasticity in a second state, the second modulus of elasticity being less than the first modulus of elasticity, a heating element selectively movable from an OFF state to an ON state to supply the SMP with heat, the SMP moving from the first state to the second state in response to the heating element moving from the OFF state to the ON state, and at least one sensor attached to the vehicle and configured to generate an electric signal in response to a force of a predetermined magnitude being applied to the vehicle to move the heating element from the OFF state to the ON state.

The vehicle may include one or more of the following optional features. For example, the at least one sensor may be a piezoelectric sensor. Additionally or alternatively, the at least one sensor may be disposed proximate to a front fascia of the vehicle.

The first vehicle component may be located under a hood panel of the vehicle.

In one configuration, the heating element may be a wire. The wire may be embedded within the SMP. Further, the wire may be in electrical communication with a power source of the vehicle, the wire receiving current from the power source when moved from the OFF state to the ON state.

A switch may be in electrical communication with the at least one sensor. The switch may be moveable from an open state to a closed state in response to the at least one sensor generating the electric signal to supply current to the heating element. Additionally or alternatively, the heating element may be a wire embedded within the SMP.

In another configuration, a vehicle includes a first component having a first portion formed from a first material and a second portion formed from a shape memory polymer (SMP) having a first modulus of elasticity in a first state and a second modulus of elasticity in a second state, the second modulus of elasticity being less than the first modulus of elasticity, a wire embedded within the second portion and selectively receiving current in an energized state to move the SMP from the first state to the second state, and at least one sensor attached to the vehicle and configured to generate an electric signal in response to a force of a predetermined magnitude being applied to the vehicle to move the wire into the energized state.

The vehicle may include one or more of the following optional features. For example, the at least one sensor may be a piezoelectric sensor. Additionally or alternatively, the at least one sensor may be disposed proximate to a front fascia of the vehicle.

The first vehicle component may be located under a hood panel of the vehicle.

In one configuration, the wire may be in electrical communication with a power source of the vehicle, the wire receiving current from the power source when in the energized state. A switch may be in electrical communication with the at least one sensor. The switch may be moveable from an open state to a closed state in response to the at least one sensor generating the electric signal to supply current to the wire.

In yet another configuration, a vehicle includes a first component having a first portion formed from a first material and a second portion formed from a shape memory polymer (SMP) having a first modulus of elasticity in a first state and a second modulus of elasticity in a second state, the second modulus of elasticity being less than the first modulus of elasticity and at least one piezoelectric sensor attached to the vehicle and configured to generate an electric signal in response to a force of a predetermined magnitude being applied to the vehicle to move the SMP from the first state to the second state.

The vehicle may include one or more of the following optional features. For example, a heating element may be selectively movable from an OFF state to an ON state to supply the SMP with heat, the SMP moving from the first state to the second state in response to the heating element moving from the OFF state to the ON state. A switch may be in electrical communication with the at least one piezoelectric sensor, the switch configured to move the heating element from the OFF state to the ON state in response to the at least one piezoelectric sensor generating the electric signal.

### BRIEF DESCRIPTION OF THE DRAWINGS

The drawings described herein are for illustrative purposes only of selected configurations and are not intended to limit the scope of the present disclosure.

FIG. 1 is a perspective view of a vehicle in accordance with the principles of the present disclosure;

FIG. 2 is a partial exploded view of the vehicle of FIG. 1 showing a hood, a frunk, a hood closeout panel, and a sightshield having a shape memory polymer (SMP) at discrete locations;

FIG. 3 is a partial exploded view of the vehicle of FIG. 1 showing a hood, a frunk, a hood closeout panel, and a sightshield in a softened state at one or more locations of the SMP;

FIG. 4 is a functional block diagram showing a piezoelectric sensor in communication with a logic board that selectively permits current to flow into the SMP in response to an electric signal from the piezoelectric sensor;

FIG. 5 is a partial side view of the vehicle of FIG. 1 in a first impact position relative to a crash-test dummy; and

FIG. 6 is a partial side view of the vehicle of FIG. 1 in a second impact position relative to a crash-test dummy.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

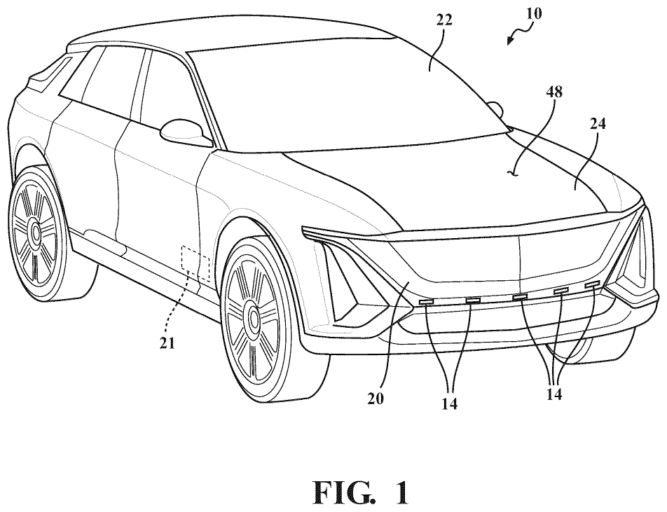

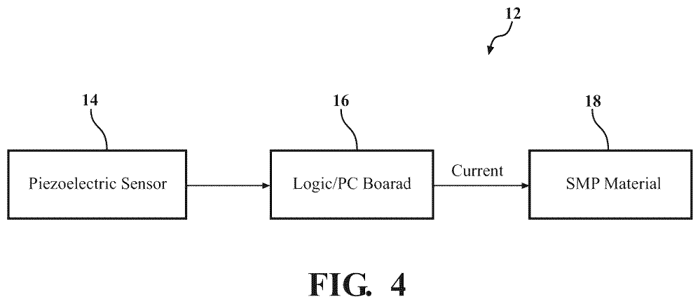

With particular reference to FIGS. 1 and 4, a vehicle 10 is provided and includes an on-demand, tunable stiffness system (TSS) 12 (FIG. 4) in accordance with the principles of the present disclosure. As will be described in greater detail below, the TSS 12 responds to a pedestrian impact event in real time by softening vehicle structure at particular locations of the vehicle 10 to allow the vehicle structure to dissipate forces associated with the vehicle 10 contacting the pedestrian or other Vulnerable Road User (VRU) in a controlled fashion. Specifically, the TSS 12 reduces Head Injury Criteria (HIC) by enabling a first peak on a deceleration curve—caused by the head of a pedestrian or VRU contacting the vehicle 10—to be reached within three (3) milliseconds of impact followed by a sudden drop. The TSS 12 achieves the foregoing reduction in HIC by softening vehicle structure in real time in an area of impact with the head of a pedestrian or VRU.

The TSS 12 includes a series of sensors 14, a switch 16, and a shape memory polymer (SMP) 18 located at various regions of the vehicle 10. As will be described, the sensors 14 are configured to detect a pedestrian impact event which, in turn, causes the switch 16 to permit current to flow into the SMP 18. The SMP 18, in response to the applied current, softens, thereby allowing the SMP 18 to more easily deform when subjected to forces associated with an impact event.

The sensors 14 may be piezoelectric sensors 14 that use the piezoelectric effect to measure changes in pressure, acceleration, temperature, strain, or force by converting the foregoing changes into an electrical charge. In the present application, the piezoelectric sensors 14 generate electrical (voltage) signals in response to a strain field. Specifically, when the piezoelectric sensors 14 detect an impact event, the sensors 14 generate an electrical signal. In one configuration, when an impact event is detected, the piezoelectric sensors 14 generate an electrical signal in less than ten (10) milliseconds. The impact event may occur when the vehicle 10 contacts a pedestrian or other VRU such as a cyclist. Alternatively, the impact event may occur when the vehicle contacts a different movable or non-movable object. Regardless of what the vehicle 10 contacts, the piezoelectric sensors 14 are configured to detect the impact and generate an electrical signal in response to the event.

The switch 16 is in communication with the piezoelectric sensors 14 and may be a logic board or printed circuit board (PCB) that causes a current to flow into the SMP 18 via wires 19 embedded within the SMP 18 in response to the electric signal(s) from the piezoelectric sensor(s) 14. The current directed into the SMP 18 may be supplied to the SMP 18 via the switch 16, which allows current from an on-board power source such as a vehicle battery 21 to flow into the SMP 18. In so doing, the current causes the SMP 18 to soften.

The SMP 18 may be located at various locations of the vehicle 10 where localized softening of vehicle structure is needed to reduce HIC values should the vehicle 10 impact a pedestrian or other VRU. Specifically, the SMP 18 may be located where a pedestrian's head is likely to impact the vehicle 10 to allow those areas of the vehicle 10 to more easily deform and absorb the energy associated with the applied load. The SMP 18 may be spread over multiple locations as needed.

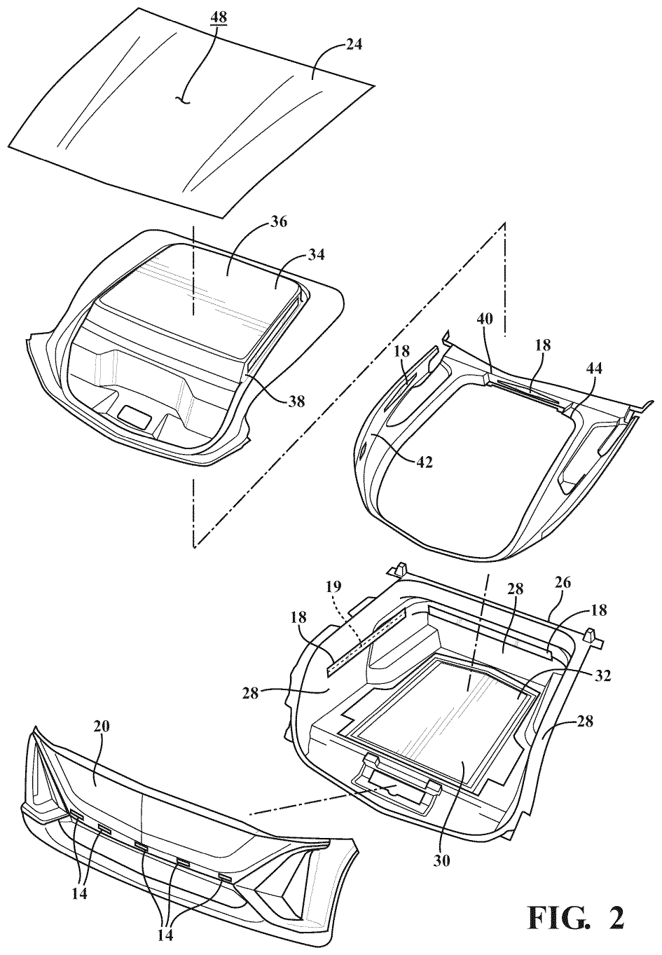

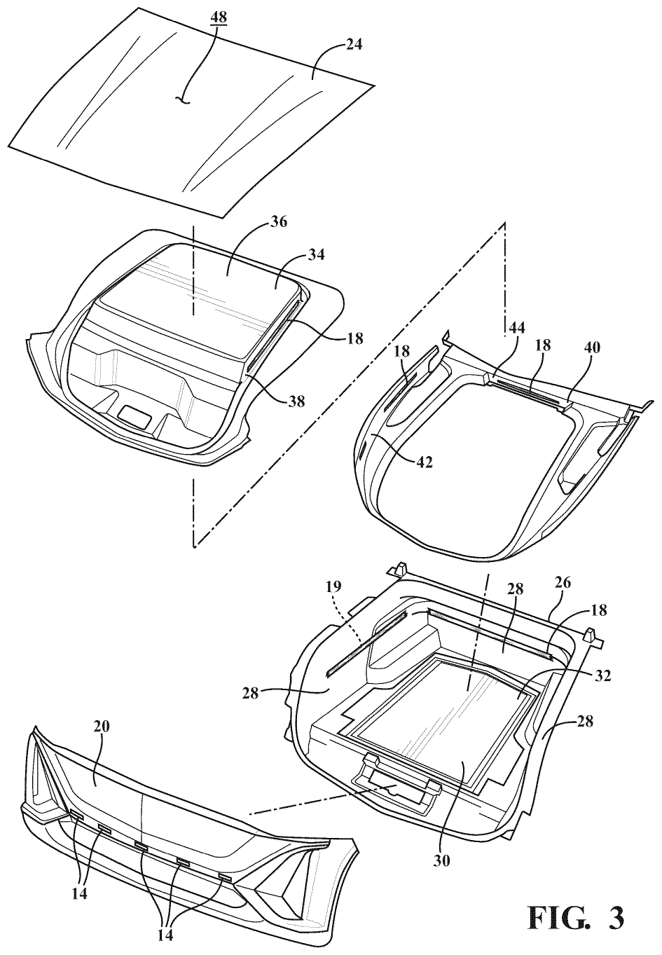

With particular reference to FIGS. 1 and 2, the piezoelectric sensors 14 are shown as being located at five (5) locations behind a front fascia 20 of the vehicle 10. While the piezoelectric sensors 14 are described and shown as being located at five (5) locations behind the front fascia 20, there could be more or fewer piezoelectric sensors 14 behind the front fascia 20. Regardless of the number of piezoelectric sensors 14, the sensors 14 are located along a length of the front fascia 20 at equal distances from one another and are located in a height direction (i.e., a Z-direction) such that the sensors 14 are in close proximity to a leg of a pedestrian when standing proximate to the front fascia 20 of the vehicle 10. The sensors 14 may be positioned in the Z-direction such that the sensors 14 are located proximate to the knee of a 50^{th} percentile male crash-test dummy. While the position of the piezoelectric sensors 14 in the Z-direction is described with respect to a 50^{th} percentile male crash-test dummy, the piezoelectric sensors 14 could be positioned at any height in the Z-direction that is likely to first impact a pedestrian or other VRU based on the front-end architecture and shape of the vehicle 10. While the piezoelectric sensors 14 are described and shown hereinafter and in the drawings as being disposed within a front fascia 20 of the vehicle 10, the sensors 14 could additionally or alternatively be located at any location of the vehicle 10 where an occupant, pedestrian, or other VRU could impact vehicle structure and, as such, could benefit from the softening of vehicle structure. For example, a piezoelectric sensor 14 may be used within a passenger compartment 22 of the vehicle 10 at a location where an occupant may contact vehicle structure. For example, a sensor could be placed near or within an instrument panel (IP) such than one or more sensors 14 are positioned to detect an impact event with the IP. In this configuration, the IP may include supporting structure that includes SMP 18 to soften the IP, thereby reducing HIC during an impact event.

With continued reference to FIGS. 1 and 2, the SMP 18 is shown as being implemented in various vehicle structure located under a hood panel 24 of the vehicle 10. Specifically, the vehicle 10 of the present application may be an electric vehicle (EV) such that the vehicle 10 is powered by one or more electric motors (none shown). Accordingly, a conventional internal combustion engine (ICE) that would typically be located underneath the hood panel 24 is not present. Rather, a frunk 26 (i.e., combination of the terms “front” and “trunk”) is disposed at a location where an ICE would be located in an effort to provide the vehicle 10 with additional storage space. While the TSS 12 will be described and shown hereinafter as being used in conjunction with an EV, the TSS 12 could be used in conjunction with vehicle structure associated with an ICE-powered vehicle and/or with a hybrid-electric vehicle (HEV) that includes both an ICE and one or more electric motors.

As shown in FIG. 2, the frunk 26 is disposed generally beneath the hood panel 24 and includes a series of walls 28 that cooperate with a bottom panel 30 to define a storage space 32. The frunk 26 may be sealed by a hood closeout panel 34 that is fixed for movement with the hood panel 24. The hood closeout panel 34 includes a top panel 36 opposing the hood panel 24 as well as a series of walls 38 that cooperate with the top panel 36 to define a portion of the storage space 32 when the hood panel 24 is in a closed position and the hood closeout panel 34 is in contact with the frunk 26. Finally, a sightshield 40 may surround the frunk 26 when the frunk 26 is installed in the vehicle 10. While the TSS 12 will be described and shown in conjunction with a frunk 26, a hood closeout panel 34, and a sightshield 40, the TSS 12 could be used with any component under the hood panel 24 such as, for example, a headlamp (not shown).

Each of the frunk 26, the hood closeout panel 34, and the sightshield 40 may include the SMP 18 at discrete locations. For example, the frunk 26 may include the SMP 18 at discrete locations of the walls 28. Similarly, the hood closeout panel 34 may include the SMP 18 at discrete locations of the walls 38 and the sightshield may include the SMP 18 at one or more sidewalls 42 and a rear wall 44. As shown in FIG. 2, the SMP 18 may include a substantially uniform height or, alternatively, may vary in height along the particular component 26, 34, 40. For example, with respect to the SMP 18 extending along and forming a portion of the walls 28 of the frunk 26, the SMP 18 may include a substantially uniform height. With respect to the SMP 18 extending along and forming a portion of the sidewalls 42 of the sightshield 40, the SMP 18 may include a variable height (i.e., a non-uniform height).

The particular location and height of the SMP 18 in each of the foregoing components 26, 34, 40 may be determined by using computer-aided engineering (CAE) software to simulate performance of the various components 26, 34, 40 in response to an applied load associated with a head-impact event. The CAE analysis will identify where the SMP 18 should be located within a specific component (i.e., location, height, and/or uniform or non-uniform height) in an effort to optimize the ability of the component to soften and reduce HIC. Accordingly, the location, height, and configuration of the SMP 18 for each component 26, 34, 40 may be tailored to the specific component 26, 34, 40 and vehicle 10 in which the components 26, 34, 40 are installed. Further, the CAE analysis can take the surrounding components into consideration when running a simulation to optimize the performance of the overall vehicle structure at a particular location. In the present example, the CAE analysis can analyze and run a simulation to determine the collective ability of the frunk 26, the hood closeout panel 34, and the sightshield 40 in reducing HIC by softening—at discrete locations of each component 26, 34, 40—in response to a head-impact event. In short, the CAE software and simulations will dictate areas in components that need to be softer to meet pedestrian and VRU head-impact requirements. Localized areas of the components 26, 34, 40 may be replaced with the SMP 18 based on the CAE analysis to determine the precise location and amount of SMP 18 to optimize performance of the particular component 26, 34, 40—as well as the system in general—in response to a load associated with a head-impact event.

The SMP 18 may be formed integrally with the foregoing components 26, 34, 40 by utilizing a dual-shot material. Specifically, the SMP 18 may be compression molded along with other polymers into the shapes shown for the frunk 26, the hood closeout panel 34, and the sightshield 40. By molding the SMP 18 at locations dictated by the CAE analysis, the foregoing components 26, 34, 40 may be softened and tailored to reduce HIC in the event that the vehicle 10 contacts a pedestrian or other VRU. When molding the components 26, 34, 40, the wire 19 may be embedded within the SMP 18 to allow the wire 19 to quickly heat the SMP 18 from within during use.

The SMP 18 associated with the foregoing components 26, 34, 40 may be in electrical communication with an on-board power supply such as the vehicle battery 21. Specifically, the SMP 18 may selectively receive current from the battery 21 when the switch 16 moves from an open state to a closed state. As will be described in greater detail below, the switch 16 may move from the open state to the closed state in response to the piezoelectric sensors 14 generating an electrical signal. As shown in FIG. 4, the switch 16 is functionally disposed between the piezoelectric sensors 14 and the SMP 18. When one or more of the piezoelectric sensors 14 generates an electrical signal in response to an impact event, the electrical signal(s) causes the switch 16 to move from the open state to the closed state to allow current to flow from the battery 21 to the SMP 18. The flow of current from the battery 21 to the SMP 18 causes the SMP 18 to soften, thereby allowing the components 26, 34, 40 to more easily deform in response to an impact or downward force (i.e., in a direction substantially normal to an outer surface 48 of the hood panel 24).

The SMP 18 softens in response to the applied current due to the material properties of the SMP 18. For example, the SMP 18 is a so-called smart polymer material that transitions from a normal state having a first stiffness to a softened state having a second stiffness less than the first stiffness on a scale of 100x when heated. In the present application, the current supplied by the battery 21 by way of the switch 16 causes current to flow within the SMP 18 via the wires 19 and, in so doing, heat the SMP 18. When the SMP 18 is heated, the SMP 18 undergoes phase change such that material properties (i.e., the modulus of elasticity (E)) of the SMP 18 change. In the present example, the modulus of elasticity of the SMP 18 is reduced, thereby reducing the ability of the SMP 18 to resist deformation when subjected to a load. Accordingly, when a load is applied to the hood panel 24 and the forces associated with the applied load are transmitted to one or more of the frunk 26, the hood closeout panel 34, and the sightshield 40, the locations of the SMP 18 within the foregoing components 26, 34, 40 will soften, thereby decreasing the ability of the component(s) 26, 34, 40 to resist being deformed. The location and amount of SMP 18 associated with each component 26, 34, 40, as well as the applied current, can be controlled in a desired fashion for an optimal solution.

When the switch 16 returns to the open state such that current is no longer supplied to the components 26, 34, 40 from the battery 21, and the SMP 18 is allowed to cool, the SMP 18 returns to its modulus of elasticity (E). In so doing, the SMP 18 returns to its original stiffness. Additionally, when the current no longer flows through the SMP 18, and the SMP 18 is permitted to cool, the SMP 18 will return to it is original shape. Accordingly, in instances when the switch 16 moves to the closed state and supplies current to the SMP 18 but the vehicle 10 did not experience an impact event, the SMP 18 will return to its original stiffness (i.e., modulus of elasticity (E)) and its original shape when the switch 16 moves to the open state and the SMP 18 is allowed to cool.

With particular reference to FIGS. 1, 5, and 6, operation of the TSS 12 will be described in detail. During operation of the vehicle 10, the piezoelectric sensors 14 are constantly monitoring the front fascia 20 of the vehicle 10 for a change in applied load, which is indicative of an impact event. Specifically, the piezoelectric sensors 14 are constantly monitoring for a condition where the front fascia 14 is subjected to a load of a predetermined magnitude. The load applied to the front fascia 20 allows the sensors 14 to identify the impact event by the load applied to one or more of the sensors 14 by the impact of the front fascia 20 with a stationary or non-stationary object.

The sensors 14, in one configuration, can be tuned such that the sensors 14 identify an impact event once a threshold load is applied thereto. In one configuration, the threshold load may be associated with the vehicle 10 contacting a specific crash test dummy at or above a predetermined speed. For example, the threshold load may be associated with the vehicle 10 contacting a fifth percentile female crash test dummy 50 at a speed equal to or greater than five (5) miles per hour. The sensors 14 may be tuned to generate an electrical (voltage) signal when a load equal to or greater than the predetermined load is applied to one or more of the sensors 14.

When one or more of the sensors 14 detects a load that is equal to or greater than the predetermined load, the electrical signal generated by the one or more sensors 14 causes the switch 16 to move from the open state to the closed state. In so doing, and as described above, the switch 16 allows current to flow from the battery 21 into the SMP 18 of the frunk 26, the hood closeout panel 34, and the sightshield 40. The current causes the SMP 18 of the foregoing components 26, 34, 40 to soften (i.e., have a lower modulus of elasticity (E)) which, in turn, allows the components 26, 34, 40—at the locations of the SMP 18—to more easily deform in a controlled fashion.

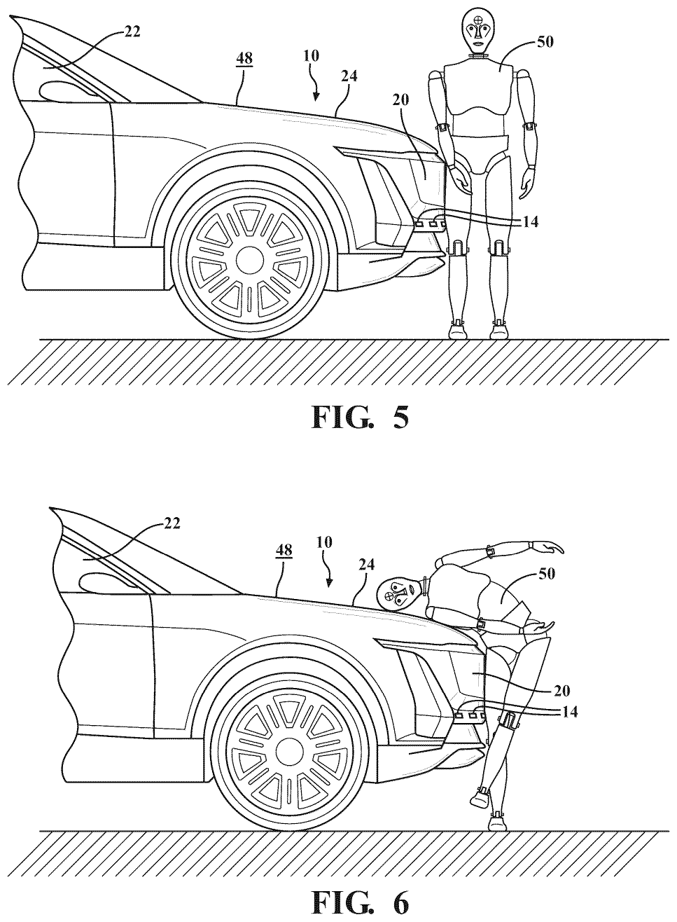

With continued reference to FIGS. 5 and 6, the change in load detected by the sensors 14 may be realized due to a change in a strain field of one or more of the sensors 14. Specifically, when the vehicle 10 initially contacts a fifth percentile crash test dummy 50 (FIG. 5), one or more of the sensors 14 immediately detects a change in the strain field of the particular sensor 14. The change in the strain field causes the sensor(s) 14 to generate an electrical signal which, in turn, moves the switch 16 from the open state to the closed state. When the switch 16 moves from the open state to the closed state, current from the battery 21 is permitted to flow into the SMP 18. It should be noted that the detection of the change in load upon the initial impact with the crash test dummy 50 occurs in less than ten (10) milliseconds. Accordingly, within ten (10) milliseconds, the sensor(s) 14 detects the impact event and causes the switch 16 to move from the open state to the closed state. In the closed state, the switch 16 will supply current to the SMP 18 for a predetermined length of time that is based on how much of a change in elasticity (E) and temperature are required.

When the current flows into the frunk 26, the hood closeout panel 34, and the sightshield 40 at the SMP 18 of each component 26, 34, 40, the SMP 18 associated with each component 26, 34, 40) is heated and, thus, softens. Accordingly, when the crash test dummy 50) moves into the position shown in FIG. 6 such that a head of the dummy 50 contacts the outer surface 48 of the hood panel 24, the SMP 18 is already heated and in a softened state. Therefore, when the head of the dummy 50 deforms the hood panel 24, the underlying components 26, 34, 40) are softened and the energy associated with the dummy's head contacting the hood panel 24 is more quickly absorbed in a controlled fashion. Accordingly, the dummy 50 experiences a lower HIC.

In the event that one or more of the sensors 14 detects a change in load that exceeds the threshold load but an impact event requiring softening of the components 26, 34, 40 via the SMP 18 is not required (i.e., if the vehicle 10 contacts a pole or other stationary object and not a pedestrian or other VRU), the switch 16 will still move from the open state to the closed state to heat the SMP 18. However, the SMP 18 will not be deformed if a force is not applied to the hood panel 24 in a direction substantially normal to the outer surface 48 of the hood panel 24. Accordingly, when the switch 16 returns to the open state and current is no longer applied to the SMP 18, the SMP 18 is allowed to cool and return to its original state. This scenario may be referred to as a false positive incident, as softening of the SMP 18 was not required to absorb forces associated with contact between a pedestrian or other VRU and the hood panel 24 of the vehicle 10. When a false positive incident occurs, the SMP 18 and, thus, the associated components 26, 34, 40, are automatically returned to their original state once cooled due to the nature of the SMP 18. Further maintenance or repair are not required to return the SMP 18 or any of the associated components 26, 34, 40 to their original state.

As described, the TSS 12 utilizes SMP 18 within vehicle components (i.e., components 26, 34, 40 in the foregoing example) to provide the vehicle 10 with an on-demand response to the vehicle 10 impacting a pedestrian or VRU while at the same time allowing the components to meet normal use requirements during use of the vehicle 10. The TSS 12 supplies the SMP 18 with current to heat the SMP 18 and, as a result, soften the SMP 18 in response to the vehicle 10 impacting a pedestrian or VRU. In so doing, the TSS 12 lowers HIC values in an effort to protect the pedestrian or VRU. The components of the vehicle 10 provided with the SMP 18, the exact locations of the SMP 18, as well as the amount of SMP 18 at each location of each component may be determined by using CAE analysis. Accordingly, the TSS 12 may be tailored to the particular vehicle 10.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising.” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second.” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory. Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICS (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A vehicle comprising:
a first vehicle component including a shape memory polymer (SMP) having a first modulus of elasticity in a first state and a second modulus of elasticity in a second state, the second modulus of elasticity being less than the first modulus of elasticity;
a heating element selectively movable from an OFF state to an ON state to supply the SMP with heat, the SMP moving from the first state to the second state in response to the heating element moving from the OFF state to the ON state; and
at least one sensor attached to the vehicle and configured to generate an electric signal in response to a force of a predetermined magnitude being applied to the vehicle to move the heating element from the OFF state to the ON state.

2. The vehicle of claim 1, wherein the at least one sensor is a piezoelectric sensor.

3. The vehicle of claim 1, wherein the at least one sensor is disposed proximate to a front fascia of the vehicle.

4. The vehicle of claim 3, wherein the first vehicle component is located under a hood panel of the vehicle.

5. The vehicle of claim 1, wherein the heating element is a wire.

6. The vehicle of claim 5, wherein the wire is embedded within the SMP.

7. The vehicle of claim 5, wherein the wire is in electrical communication with a power source of the vehicle, the wire receiving current from the power source when moved from the OFF state to the ON state.

8. The vehicle of claim 1, further comprising a switch in electrical communication with the at least one sensor.

9. The vehicle of claim 8, wherein the switch is moveable from an open state to a closed state in response to the at least one sensor generating the electric signal to supply current to the heating element.

10. The vehicle of claim 9, wherein the heating element is a wire embedded within the SMP.

11. A vehicle comprising:
a first component including a first portion formed from a first material and a second portion formed from a shape memory polymer (SMP) having a first modulus of elasticity in a first state and a second modulus of elasticity in a second state, the second modulus of elasticity being less than the first modulus of elasticity;
a wire embedded within the second portion and selectively receiving current in an energized state to move the SMP from the first state to the second state; and
at least one sensor attached to the vehicle and configured to generate an electric signal in response to a force of a predetermined magnitude being applied to the vehicle to move the wire into the energized state.

12. The vehicle component of claim 11, wherein the at least one sensor is a piezoelectric sensor.

13. The vehicle of claim 11, wherein the at least one sensor is disposed proximate to a front fascia of the vehicle.

14. The vehicle of claim 13, wherein the first vehicle component is located under a hood panel of the vehicle.

15. The vehicle of claim 11, wherein the wire is in electrical communication with a power source of the vehicle, the wire receiving current from the power source when in the energized state.

16. The vehicle of claim 11, further comprising a switch in electrical communication with the at least one sensor.

17. The vehicle of claim 16, wherein the switch is moveable from an open state to a closed state in response to the at least one sensor generating the electric signal to supply current to the wire.

18. A vehicle comprising:
a first component including a first portion formed from a first material and a second portion formed from a shape memory polymer (SMP) having a first modulus of elasticity in a first state and a second modulus of elasticity in a second state, the second modulus of elasticity being less than the first modulus of elasticity; and
at least one piezoelectric sensor attached to the vehicle and configured to generate an electric signal in response to a force of a predetermined magnitude being applied to the vehicle to move the SMP from the first state to the second state.

19. The vehicle component of claim 18, further comprising a heating element selectively movable from an OFF state to an ON state to supply the SMP with heat, the SMP moving from the first state to the second state in response to the heating element moving from the OFF state to the ON state

20. The vehicle of claim 19, further comprising a switch in electrical communication with the at least one piezoelectric sensor, the switch configured to move the heating element from the OFF state to the ON state in response to the at least one piezoelectric sensor generating the electric signal.
